(19) United States
(12) Patent Application Publication
(10) Pub. No.: US 2023/0219335 A1
(43) Pub. Date: Jul. 13, 2023

(54) LAMINATING SYSTEM, COOLING DEVICE FOR LAMINATING SYSTEM, FILM STICKING-AND-CUTTING DEVICE, FILM PEELING DEVICE, LAMINATING METHOD, AND MANUFACTURING METHOD OF LAMINATED PRODUCT

(71) Applicant: SHINWA CONTROLS CO., LTD, Kawasaki-Shi (JP)

(72) Inventors: Michio TAKAYAMA, Kawasaki-Shi (JP); Ayumi MORIMUNE, Kawasaki-Shi (JP); Yousuke IKEDA, Kawasaki-Shi (JP)

(73) Assignee: SHINWA CONTROLS CO., LTD, Kawasaki-Shi (JP)

(21) Appl. No.: 17/906,876

(22) PCT Filed: Jun. 8, 2022
(86) PCT No.: PCT/JP2022/023064

§ 371 Date: Sep. 21, 2022

(30) Foreign Application Priority Data
Aug. 23, 2021 (JP) 2021-135903

(51) Int. Cl. B32B 37/08; B32B 37/00; B32B 37/22; B32B 38/00; B32B 37/10

(52) U.S. Cl. CPC B32B 37/08; B32B 37/0046; B32B 37/22; B32B 38/0004; B32B 37/1018; B32B 2457/08

(57) ABSTRACT

A laminating system according to one embodiment includes: a film sticking-and-cutting device that sticks a film fed from a roll to a workpiece, and cuts the film at a position where the film is not overlapped with the workpiece; and a laminator that receives the workpiece delivered from the film sticking-and-cutting device, and presses the film stuck to the workpiece to the workpiece to join the film to the workpiece. The film sticking-and-cutting device includes a cooling unit that cools the workpiece or the film, before the film is cut. The laminating system may further includes a cooling device that cools the film by supplying air to the film on the workpiece delivered from the laminator, and a film peeling device that peels a layer from the film on the workpiece.

### FIELD OF THE INVENTION

Embodiments of the present invention relate to: a laminating system for laminating, for example, a circuit board with an insulating resin film; to a cooling device for laminating system used therefor; to a film sticking-and-cutting device; and to a film peeling device. In addition, the embodiments of the present invention relate to a laminating method, and a manufacturing method of a laminated product.

### BACKGROUND ART

A laminating system comprising a vacuum laminator has been known in the past (e.g. WO2016/199687A1).

In a laminating system comprising a vacuum laminator, for example, a film fed from a roll is first temporarily stuck to a workpiece, such as a circuit board. Then, the film extending between the roll and the workpiece is cut, and the film temporarily stuck to the workpiece is separated from the roll. Thereafter, the workpiece with the film is conveyed to a vacuum chamber of the vacuum laminator.

After the work has been conveyed, an inside of the vacuum chamber is controlled to a vacuum state. Thereafter, a pressure difference is created, and the film being heated is pressed onto the workpiece by a pressing means such as a diaphragm. Thereafter, the pressing means is pulled away from the film. In such a laminating process, the film including a joint layer to be joined to a workpiece and a supply layer supporting the joint layer may be used. In this case, after the pressing means has been pulled away from the film, a step of peeling the support layer from the film is usually performed.

The vacuum laminate performs the lamination by expelling air between the workpiece and the film. This can reduce trapping of babbles between the workpiece and the film. The reduction of bubble trap can avoid an event in which adverse effects may occur in subsequent processes by the bubbles. In addition, a laminated product formed via the laminating process can be well finished, to thereby improve a throughput.

### SUMMARY OF THE INVENTION

In the process of the aforementioned laminating system, there is a possibility that the film cannot be properly cut and/or that one of two layers of the film cannot be properly peeled, in accordance with a condition of the film or the workpiece.

For example, when the film has been temporarily stuck to the workpiece and is then cut, the film may partially melt or may entirely soften, in accordance with an environmental temperature and/or a temperature of the workpiece. In this case, a cut surface of the film may be roughened and/or the film may be wrinkled or stretched.

In addition, the film and the workpiece after the vacuum lamination have a high temperature, so that adhesiveness between the two layers of the film may be impaired. In this case, a part of the layer on the workpiece may adhere to the layer to be peeled. When these layers are peeled from each other in such a state, the part of the layer on the workpiece may be peeled, so that the layer on the workpiece may have a roughened surface. When the workpiece is a circuit board and a laminated layer is an insulating layer, a roughened surface of the insulating layer may easily cause a short circuit. In addition, when the circuit board is incorporated into a multilayer board, the multilayer board may be defective.

The film and the workpiece after the vacuum lamination have a high temperature and thus expend. In this case, warpage may occur because of a difference between a linear expansion coefficient of the film and that of the workpiece. This warpage decreases a throughput.

The object of the present invention is to provide a laminating system, a cooling device for laminating system, a film sticking-and-cutting device, a film peeling device, a laminating method, and a manufacturing method of a laminated product, which are capable of improving a non-defective product rate of laminated products formed via a laminating process.

A laminating system according to one embodiment of the present invention comprises: a film sticking-and-cutting device that sticks a film fed from a roll to a workpiece, and cuts the film at a position where the film is not overlapped with the workpiece; and a laminator that receives the workpiece delivered from the film sticking-and-cutting device, and presses the film stuck to the workpiece to the workpiece to join the film to the workpiece;

wherein the laminating system comprises a cooling device that cools the workpiece or the film by air, before the film is cut by the film sticking-and-cutting device.

The cooling device may cool the workpiece by supplying air to the workpiece before the workpiece reaches a sticking position of the film in the film sticking-and-cutting device, or cool the film by supplying air to the film before the film is stuck to the workpiece, or cool the film by supplying air to the film on the workpiece between the sticking position of the film in the film sticking-and-cutting device and a cutting position of the film therein.

A laminating system according to one embodiment of the present invention comprises:

a vacuum laminator that receives, in a vacuum chamber, a workpiece to which a film including a support layer and a joint layer is stuck, with the joint layer being in direct contact with the workpiece, creates a vacuum state in the vacuum chamber, and presses the film to the workpiece to join the film to the workpiece, while heating the film;

a cooling device that cools the film on the workpiece delivered from the vacuum laminator, by supplying air to the film; and

a film peeling device that peels the support layer from the film on the workpiece delivered from the cooling device;

wherein the cooling device varies the supply rate of the air in accordance with a conveyance pattern of the workpiece and/or a condition of the film on the workpiece.

A cooling device for laminating system according to one embodiment of the present invention comprises:

an entrance for a workpiece on which a film is not yet stacked or a workpiece on which a film has been already stacked, and an exit for the workpiece;

wherein

the cooling device for laminating system cools, between the entrance and the exit, the workpiece on which the film is not yet stacked by supplying air to the workpiece, or the film on the workpiece on which the film has been already stacked by supplying air to the film, and

the cooling device for laminating system varies the supply rate of the air in accordance with at least any of a conveyance pattern of the workpiece, a condition of the workpiece, and a condition of the film on the workpiece.

A film sticking-and-cutting device according to one embodiment of the present invention sticks a film fed from a roll to a workpiece, and cuts the film at a position where the film is not overlapped with the workpiece,

wherein the film sticking-and-cutting device includes a cooling unit that cools the workpiece or the film by air, before the film is cut.

The cooling unit may cool the workpiece by supplying air to the workpiece before the workpiece reaches a sticking position of the film, or cool the film before the film is stuck to the workpiece by supplying air to the film, or cool the film on the workpiece between the sticking position of the film and a cutting position of the film by supplying air to the film.

A film peeling device according to one embodiment of the present invention peels, from a film including a support layer and a joint layer, the support layer, with the joint layer being directly joined to a workpiece to which the film is joined,

wherein

the film peeling device comprises a cooling unit that cools the film by supplying air to the film on the workpiece, before the support layer is peeled, and

the cooling unit varies the supply rate of the air in accordance with a conveyance pattern of the workpiece and/or a condition of the film on the workpiece.

A laminating method according to one embodiment of the present invention comprises:

a film sticking-and-cutting step that sticks a film fed from a roll to a workpiece, and cuts the film at a position where the film is not overlapped with the workpiece; and

a laminating step that receives the workpiece delivered after the film sticking-and-cutting step, and presses the film stuck to the workpiece to the workpiece to join the film to the workpiece;

wherein the laminating method comprises a cooling step that cools the workpiece or the film by air, before the film is cut in the film sticking-and-cutting step.

The cooling step may cool the workpiece by supplying air to the workpiece before the workpiece reaches a sticking position of the film in the film sticking-and-cutting step, or cool the film by supplying air to the film before the film is stuck to the workpiece, or cool the film by supplying air to the film on the workpiece between the sticking position of the film in the film sticking-and-cutting step and a cutting position of the film therein.

In addition, a manufacturing method of a laminated product according to one embodiment of the present invention comprises:

a film sticking-and-cutting step that sticks a film fed from a roll to a workpiece, and cuts the film at a position where the film is not overlapped with the workpiece; and

a laminating step that receives the workpiece delivered after the film sticking-and-cutting step, and presses the film stuck to the workpiece to the workpiece to join the film to the workpiece;

wherein the manufacturing method comprises a cooling step that cools the workpiece or the film by air, before the film is cut in the film sticking-and-cutting step.

A laminating method according to one embodiment of the present invention comprises:

a vacuum laminating step that receives, in a vacuum chamber, a workpiece to which a film including a support layer and a joint layer is stuck, with the joint layer being in direct contact with the workpiece, creates a vacuum state in the vacuum chamber, and presses the film to the workpiece to join the film to the workpiece, while heating the film;

a cooling step that cools the film on the workpiece delivered after the vacuum laminating step, by supplying air to the film; and

a film peeling step that peels the support layer from the film on the workpiece delivered from the cooling step;

wherein the cooling step varies the supply rate of the air in accordance with a conveyance pattern of the workpiece and/or a condition of the film on the workpiece.

In addition, a manufacturing method of a laminated product according to one embodiment of the present invention comprises:

a vacuum laminating step that receives, in a vacuum chamber, a workpiece to which a film including a support layer and a joint layer is stuck, with the joint layer being in direct contact with the workpiece, creates a vacuum state in the vacuum chamber, and presses the film to the workpiece to join the film to the workpiece, while heating the film;

a cooling step that cools the film on the workpiece delivered after the vacuum laminating step, by supplying air to the film; and

a film peeling step that peels the support layer after the film on the workpiece delivered from the cooling step;

wherein the cooling step varies the supply rate of the air in accordance with a conveyance pattern of the workpiece and/or a condition of the film on the workpiece.

The present invention can improve a non-defective product rate of laminated products.

### BRIEF DESCRIPTION OF THE DRAWINGS

FIG. 1 is a view schematically showing a board laminating system according to a first embodiment.

FIG. 2 is a schematic enlarged view of a film sticking-and-cutting device of the board laminating system according to the first embodiment.

FIG. 3 is a graph showing a relationship between a conveyance pattern of a workpiece in the board laminating system according to the first embodiment, and a blowing pattern of a cooling unit in the film sticking-and-cutting device and a downstream cooling device.

FIG. 4 is a view schematically showing a board laminating system according to a second embodiment.

FIG. 5 is a view schematically showing a board laminating system according to a third embodiment.

FIG. 6 is a view schematically showing a board laminating system according to a fourth embodiment.

FIG. 7 is a view schematically showing a board laminating system according to a fifth embodiment.

FIG. 8 is a view schematically showing a semiconductor manufacturing system comprising a film sticking-and-cutting device according to a sixth embodiment.

### DETAILED DESCRIPTION OF THE INVENTION

Respective embodiments are described in detail herebelow, with reference to the attached drawings.

### First Embodiment

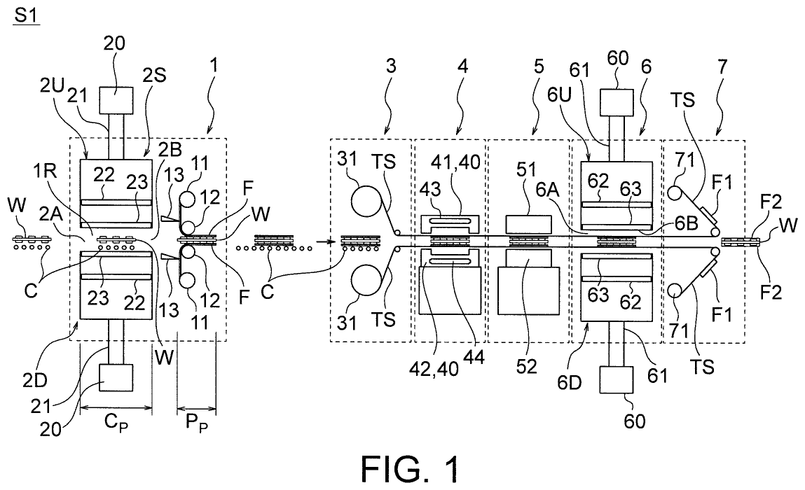

FIG. 1 schematically shows a board laminating system S1 as a laminating system according to a first embodiment. The board laminating system S1 shown in FIG. 1 comprises a film sticking-and-cutting device 1, a conveyance-sheet feeding device 3, a vacuum laminator 4, a flat pressing device 5, a downstream cooling device 6, and a conveyance-sheet winding device 7.

The board laminating system S1 is a system that continuously laminates workpieces W that are conveyed sequentially. A workpiece W passes through the film sticking-and-cutting device 1, the conveyance-sheet feeding device 3, the vacuum laminator 4, the flat pressing device 5, the downstream cooling device 6, and the conveyance-sheet winding device 7, in this order.

The workpiece W is conveyed by a simply shown conveyor C from the film sticking-and-cutting device 1 up to an entrance of the conveyance-sheet feeding device 3. Thereafter, the workpiece W is conveyed by a conveyance sheet TS extending from the conveyance-sheet feeding device 3 to the conveyance-sheet winding device 7.

For example, the workpiece W is a printed board. Insulating layers serving as joint layers are laminated on both surfaces of the printed board. The printed board may be of a flexible type or of a rigid type. The workpiece W is not specifically limited, and may be a semiconductor wafer. When the workpiece W is a semiconductor wafer, a dry resist film may be laminated on the semiconductor wafer. Lamination may be performed on only one surface of the workpiece W.

The film sticking-and-cutting device 1 includes a pair of film supply rolls 11 around which films F are wound, a pair of sticking members 12 that press the films fed from the respective film supply rolls 11 onto the workpiece W to stick the films to the workpiece W, a pair of cutters 13 that cut the films F, and an upstream cooling unit 2S. In this embodiment, the conveyer C is located to pass through the film sticking-and-cutting device 1. The film sticking-and-cutting device 1 is provided with a conveyance path 1R allowing the passage of a part of the conveyor C.

The pair of film supply rolls 11, the pair of sticking members 12, and the pair of cutters 13 are respectively disposed on one side (upper side in FIG. 1) and the other side (lower side in FIG. 1) with respect to a conveyance path 1R. The sticking member 12 on one side is located close to the conveyance path 1R. The film supply roll 11 on one side is located at a position farther away from the conveyance path 1R than the sticking member 12. The cutter 13 on one side is located such that it can move close to or away from a part of a film F, which extends between the film supply roll 11 on one side and the sticking member 12 on one side. Similarly, the sticking member 12 on the other side is located close to the conveyance path 1R. The film supply roll 11 on the other side is located at a position farther away from the conveyance path 1R than the sticking member 12. The cutter 13 on the other side is located such tat it can move close to or away from a part of a film F, which extends between the film supply roll 11 on the other side and the sticking member 12 on the other side.

The film sticking-and-cutting device 1 first cools a workpiece W, which has been received in the conveyance path 1R from outside, by the upstream cooling unit 2S. Thereafter, the workpiece W is delivered from the upstream cooling unit 2S toward the sticking members 12. Then, the sticking members 12 stick films F, and the cutters 13 cut the films F. The reference numeral Cp indicates a cooling position by the upstream cooling unit 2S, which is defined inside the film sticking-and-cutting device 1. The upstream cooling unit 2S includes an entrance 2A and an exit 2B for the workpiece W, and the cooling position Cp is defined between the entrance 2A and the exit 2B. The reference numeral Pp indicates a sticking position (process position) by the sticking members 12, which is defined inside the film sticking-and-cutting device 1. Namely, the upstream cooling unit 2S is configured to supply air to the workpiece W to cool it, before the workpiece W reaches the sticking position Pp for the films F.

The upstream cooling unit 2S includes a first cooling unit 2U located on one side of the conveyance path 1R, and a second cooling unit 2D located on the other side of the conveyance path 1R. Each of the first cooling unit 2U and the second cooling unit 2D includes a temperature-regulated air supply source 20, a duct 21, a fan filter unit 22, and an air supplying part 23.

The temperature-regulated air supply source 20 may be an air conditioning device including a refrigeration circuit, for example. The duct 21 allows temperature-regulated air from the temperature-regulated air supply source 20 to flow therethrough. The fan filter unit 22 includes a fan and a filter. In the filter unit 22, the fan is rotated so that the air from the duct 21 is delivered toward the air supplying part 23 through the filter. The filter may be a HEPA filter or a ULPA filter. The air supplying part 23 supplies the air from the fan filter unit 22 to the workpiece W on the conveyance path 1R.

In this embodiment, the air supplying part 23 of the first cooling unit 2U supplies air to a upper surface of the workpiece W so that the workpiece W is cooled. The air supplying part 23 of the second cooling unit 2D supplies air to a lower surface of the workpiece W so that the workpiece W is cooled. The air supplying part 23 may be a punching plate formed of a flat plate in which a plurality of through holes are regularly arranged. In this case, a flow rate and a pressure of the air toward the workpiece W from the entire area of the air supplying part 23 can be made uniform, whereby the workpiece W can be uniformly cooled as a whole.

The upstream cooling unit 2S in this embodiment can adjust a supply rate of the air from the first cooling unit 2U and a supply rate of the air from the second cooling unit 2D, respectively. The supply rate of the air can be adjusted by adjusting a rotation speed of the fan in the fan filter unit 22. Alternatively, the supply rate of the air can be adjusted by adjusting a flow rate of the air supplied by the temperature-regulated air supply source 20.

In detail, the upstream cooling unit 2S in this embodiment can vary the supply rate of the air, in accordance with a conveyance pattern of a workpiece W and/or a condition of the workpiece W. Specifically, in each of the first cooling unit 2U and the second cooling unit 2D, when the workpiece W is moved from the entrance 2A toward an intermediate position between the entrance 2A and the exit 2B, the upstream cooling unit 2S in this embodiment gradually increases the supply rate of the air, then maintains constant the supply rate of the air, and then gradually decreases the supply rate of the air.

In more detail, in this embodiment, the workpiece W is conveyed in such a manner that it is repeatedly stopped and moved in a cyclic manner. The conveyor C, the conveyance-sheet feeding device 3, and the conveyance-sheet winding device 7, which constitute a conveyance mechanism, realize a conveyance pattern of the workpiece W in which the workpiece W is intermittently moved, i.e., the workpiece W is repeatedly stopped and moved in a cyclic manner, by means of a series of an acceleration/deceleration signal and a stop signal which are inputted to the conveyance mechanism in a predetermined cycle. The upstream cooling unit 2S receives the aforementioned acceleration/deceleration signal and the stop signal, and converts, in synch with these signals, the acceleration/deceleration signal and the stop signal to an increase/decrease signal for the supply rate of the air and a maintenance signal for the supply rate of the air, so as to control the supply rate of the air.

Specifically, an acceleration command signal for the workpiece W is converted to a decrease command signal for the supply rate of the air. A speed maintenance signal to a certain speed for the workpiece W is converted to a maintenance command signal to a certain value for the supply rate of the air. A deceleration command signal for the workpiece W is converted to an increase command signal of the supply rate of the air. A stop signal for the workpiece W is converted to a maintenance command signal to a certain value for the supply rate of the air.

In this embodiment, the workpiece W is stopped respectively at the cooling position Cp in the film sticking-and-cutting device 1, the sticking position Pp in the film sticking-and-cutting device 1, the conveyance-sheet feeding device 3, the vacuum laminator 4, the flat pressing device 5, the downstream cooling device 6, and the conveyance-sheet winding device 7. Thereafter, the workpiece W is moved toward a downstream device.

From when the workpiece W entering from the entrance 2A until when the workpiece W stops inside the upstream cooling unit 2S, the upstream cooling unit 2S gradually increases the supply rate of the air to the workpiece W in accordance with the aforementioned conversion of the signals. Then, the upstream cooling unit 2S maintains constant the supply rate of the air to the workpiece W stopped inside the upstream cooling unit 2S. Then, the upstream cooling unit 2S gradually decreases the supply rate of the air to the workpiece W which is accelerated from the stopped state so as to be delivered from the exit 2B.

On the other hand, as described above, the upstream cooling unit 2S can vary the supply rate of the air, in accordance with a state of the workpiece W. In this case, the upstream cooling unit 2S may supply air at a constant supply rate, until the workpiece W therein reaches a predetermined temperature or lower.

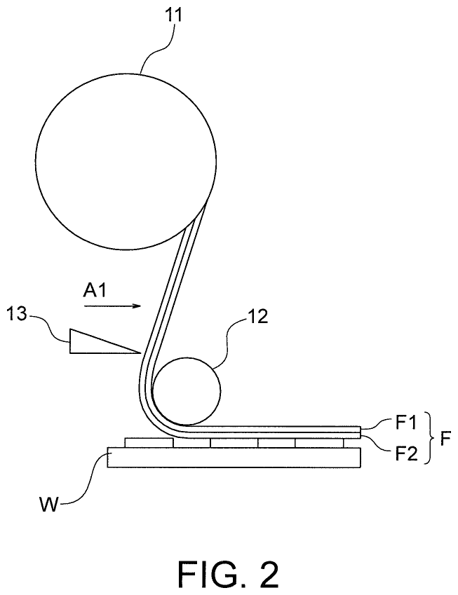

The workpiece W, which has been cooled by the upstream cooling unit 2S as described above, is delivered from the upstream cooling unit 2S to the sticking members 12. FIG. 2 shows a schematic enlarged view showing an area around the sticking member 12 in the film sticking-and-cutting device 1.

In view of FIGS. 1 and 2, the sticking member 12 holds a distal end portion of the film F fed from the film supply roll 1, and presses the distal end portion of the film F held by the sticking member 12 onto a front end portion of a workpiece S along with the movement of the workpiece W, and thereafter presses the film F fed by the movement of the workpiece W onto the upper surface or the lower surface of the workpiece W to stick or overlap the film F to or with the workpiece W.

Then, in the course of the sticking of the film F by the sticking member 12, the cutter 13 in this embodiment cuts the film F at a position where the film F is not overlapped with the workpiece W, in a direction of the arrow A1 in FIG. 2. Thus, the film F stuck to the workpiece W is separated from the film supply roll 11. A portion of the film F belonging to the work W, which is cut by the cutter 13 and is not yet stuck to the workpiece W, is then caught between the workpiece W and the sticking member 12 along with the movement of the workpiece W so as to be stuck to the workpiece W up to its rear end portion.

On the other hand, a distal end portion of the film F belonging to the film supply roll 11, which is cut by the cutter 13, is held by the sticking member 12 in conjunction with the cutting, for example. Thus, the film F can be similarly stuck to a next workpiece W. The aforementioned sticking and cutting actions are performed simultaneously by the sticking member 12 and the cutter 13 on one side of the conveyance path 1R, and the sticking member 12 and the cutter 13 on the other side of the conveyance path 1R. The cutter 13 may use a slit cutter or a roll cutter.

In this embodiment, a position of the film F stuck to the workpiece W may be maintained by a melted portion provided partially between the workpiece W and the film F. In this case, the melted portion is formed by melting a part of the film F, and a heating means and a pressing means, not shown, are provided. Alternatively, the position of the film F may be maintained by an adhesive provided partially between the workpiece W and the film F.

The film F used in this embodiment includes a support layer F1 and an insulating layer F2 as a joint layer. The film F is stuck to the workpiece W with the insulting layer F2 being in direct contact with the workpiece W. However, the film F may be a monolayer film. The conveyance-sheet winding device 7 also functions as a peeling device of the support layer F1, details of which will be described later. Peeling of the support layer F1 is performed by adhering the support layer F1 to the conveyance sheet TS which is wound by the conveyance-sheet winding device 7. In order to realize such peeling, in this embodiment, an adhesive portion is provided on the support layer F1. When the workpiece W is conveyed to the conveyance-sheet feeding device 3, the adhesive portion provided on the support layer F1 is adhered to the conveyance sheet TS fed by the conveyance-sheet feeding device 3.

The conveyance-sheet feeding device 3 includes a pair of conveyance sheet supply rolls 31 around which the conveyance sheets TS are respectively wound. A downstream end portion of the conveyor C is positioned in the conveyance-sheet feeding device 3. One of the pair of conveyance sheet supply rolls 31 is located on one side of the conveyor C and the workpiece W (upper side in FIG. 1), and the other of the pair of conveyance sheet supply rolls 31 is located on the other side (lower side in FIG. 1) of the conveyor C and the workpiece W.

A distal end of the conveyance sheet TS fed from the conveyance-sheet feeding device 3 is connected to the conveyance-sheet winding device 7. The conveyance sheet TS extending between the conveyance-sheet feeding device 3 and the conveyance-sheet winding device 7 is passed through the vacuum laminator 4, the flat pressing device 5, and the downstream cooling device 6.

The conveyance-sheet feeding device 3 holds the workpiece W with the films F, between the conveyance sheets TS fed from the pair of conveyance sheet supply rolls 31. At this time, in this embodiment, the aforementioned adhesive portion provided on the support layer F1 of the film F is adhered to the conveyance sheet TS. When the conveyance sheets TS are wound by the conveyance-sheet winding device 7, the workpiece 7 held between the pair of conveyance sheets TS is moved toward the conveyance-sheet winding device 7. Thus, the workpiece W with the films F passes sequentially through the vacuum laminator 4, the flat pressing device 5, and the downstream cooling device 6 to reach the conveyance-sheet winding device 7.

The vacuum laminator 4 includes a first chamber half 41 and a second chamber half 42. The first chamber half 41 is located on one side (upper side in FIG. 1) with respect to a conveyance route formed by the pair of conveyance sheets TS, and the second chamber half 42 is located on the other side (lower side in FIG. 1) with respect to the conveyance route formed by the pair of conveyance sheets TS.

When the workpiece W with the films F is conveyed to the vacuum laminator 4, the first chamber half 41 and the second half 42 sandwich therebetween the workpiece W with the films F through the pair of the conveyance sheets TS. The first chamber half 41 and the second chamber half 42 come into contact with each other to form a vacuum camber 40. The vacuum chamber 40 receives the workpiece W with the films F. Thereafter, the vacuum laminator 40 degasses the vacuum chamber 40 to create therein a vacuum state, and presses the film F onto the workpiece W while heating the films F so that the workpiece W and the films F are joined to each other.

In this embodiment, heating of the film F is performed by a first heater 43 provided on the first chamber half 41 and a second heater 44 provided on the second chamber half 42. Pressing of the film F to the workpiece W is performed by diaphragms, not shown, provided on the first chamber half 41 and the second chamber half 42, respectively. The diaphragm can press the workpiece W by forming a pressure difference between the workpiece W side and its opposite side. However, a means for pressing the film F onto the workpiece W is not particularly limited. A pressure may be mechanically applied by driving a press plate by a cylinder or the like.

In this embodiment, the vacuum laminator 4 is used because trapping of air between the workpiece W and the film F must be suppressed. However, suppression of air trap is not so strongly required, the vacuum laminator 4 may be replaced with a general heating and pressing laminator.

The flat pressing device 5 includes a first press plate 51 and a second press plate 52. The first press plate 51 is located on one side (upper side in FIG. 1) with respect to the conveyance route formed by the pair of conveyance sheets TS, and the second plate 52 is located on the other side (lower side in FIG. 1) with respect to the conveyance route formed by the pair of conveyance sheets TS. When the workpiece W with the films F is conveyed to the flat pressing device 5, the first press plate 51 and the second press plate 52 sandwich therebetween the workpiece W with the films F through the pair of the conveyance sheets TS, and heat and press the workpiece W with the films F. Each of the first press plate 51 and the second press plate 52 incorporates a heater, and each heater heats the workpiece W with the films F.

The downstream cooling device 6 cools the workpiece W with the films F delivered from the flat pressing device 5. The downstream cooling device 6 has basically the same structure as the upstream cooling unit 2S, and controls the supply rate of the air similarly to the cooling unit 2S.

The downstream cooling device 6 includes a first downstream cooling unit 6U located on one side (upper side in FIG. 1) with respect to the conveyance route formed by the pair of conveyance sheets TS, and a second downstream cooling unit 6D located on the other side (lower side in FIG. 1) with respect to the conveyance route formed by the pair of conveyance sheets TS. Each of the first downstream cooling unit 6U and the second downstream cooling unit 6D includes a temperature-regulated air supply source 60, a duct 61, an fan filter unit 62, and an air supplying part 63.

Air is supplied from the air supplying part 63 of the first downstream cooling unit 6U to the film F on the upper surface of the workpiece W, so that the film F is cooled. Air is supplied from the air supplying part 63 of the second downstream cooling unit 6D to the film F on the lower surface of the workpiece W, so that the film F is cooled. Since the structures of the temperature-regulated air supply source 60, the duct 61, the fan filter unit 62, and the air supplying part 63 are the same as those of the upstream cooling unit 2S, detailed description thereof is omitted.

Similarly to the upstream cooling unit 2S, the downstream cooling device 6 can also can vary the supply rate of the air, in accordance with a conveyance pattern of the workpiece W and a condition of the workpiece W, more detail, a condition of the film F on the workpiece W. Specifically, in each of the first downstream cooling unit 6U and the second downstream cooling unit 6D, when the workpiece W is moved from an entrance 6A toward an intermediate position between the entrance 6A and an exit 6B, the downstream cooling device 6 also gradually increases the supply rate of the air, then maintains constant the supply rate of the air, and then gradually decreases the supply rate of the air. Such control of the air supply rate is similar to the control in the case of the upstream cooling unit 2S, and is performed based on a series of an acceleration/deceleration signal and a stop signal transmitted to the conveyer C, the conveyance-sheet feeding device 3, and the conveyance-sheet winding device 7. Thus, detailed description thereof is omitted.

On the other hand, as described above, the downstream cooling device 6 can vary the supply rate of the air in accordance with a state of a film F on the workpiece W. In this case, the downstream cooling device 6 may supply air at a constant supply rate, until the film F reaches a predetermined temperature or lower.

The conveyance-sheet winding device 7 includes a pair of conveyance-sheet winding rolls 71 each of which winds the conveyance sheet TS. One of the conveyance-sheet winding rolls 71 is located on one side (upper side in FIG. 1) with respect to the conveyance route formed by the pair of conveyance sheets TS, and the other of the pair of conveyance-sheet winding rolls 71 located on the other side (lower side in FIG. 1) with respect to the conveyance route formed by the pair of conveyance sheets TS.

The conveyance-sheet winding device 7 moves the workpiece W held between a pair of conveyance sheets TS toward the conveyance-sheet winding device 7 by winding the conveyance sheets TS by means of the pair of conveyance-sheet winding rolls 71. In this embodiment, the conveyance-sheet winding device 7 functions as a film peeling device that peels the support layer F1 from the film F on the workpiece W. As described above, peeling of the support layer F1 is realized by adhering the support layer F1 to the conveyance sheet TS through the adhesive portion. After the support layer F1 has been peeled, the workpiece W laminated with only the insulating layer F2 is taken outside the conveyance-sheet winding device 7.

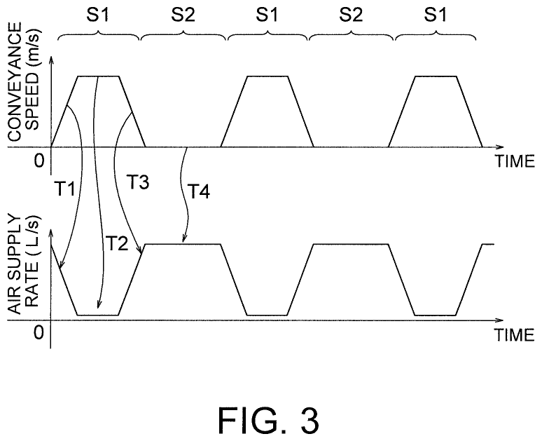

FIG. 3 shows a graph showing a relationship between a conveyance pattern of the workpiece W in the board laminating system S1 according to this embodiment and a blowing pattern of the upstream cooling unit 2S in the film sticking-and-cutting device 1 and the downstream cooling device 6.

The upper graph in FIG. 3 shows a conveyance pattern of the workpiece W. The axis of abscissa of the upper graph in FIG. 3 shows a time, and the axis of ordinate thereof shows a conveyance speed (m/s) of the workpiece W. The lower graph in FIG. 3 shows a blowing pattern of each of the upstream cooling unit 2S and the downstream cooling device 6. The axis of abscissa of the lower graph in FIG. 3 shows a time, and the axis of ordinate thereof shows an air supply rate (L/s).

A range indicated by the reference numeral S1 corresponds to an acceleration/deceleration command signal. A range indicted by the reference numeral S2 corresponds to a stop command signal. In this embodiment, as shown by the acceleration/deceleration command signal S1, after the workpiece W has been accelerated at a constant acceleration, the workpiece W is then maintained at a constant speed, and is thereafter decelerated at a constant deceleration to stop. As shown in the stop command signal S2, the workpiece W is stopped for a certain period of time. Thereafter, the workpiece W is accelerated and decelerated in the same pattern. In this manner, the workpiece W is repeatedly stopped and moved, i.e., the workpiece W is intermittently moved.

The workpiece W is stopped respectively at the cooling position Cp in the film sticking-and-cutting device 1, the sticking position Pp in the film sticking-and-cutting device 1, the conveyance-sheet feeding device 3, the vacuum laminator 4, the flat pressing device 5, the downstream cooling device 6, and the conveyance-sheet winding device 7. At the cooling position Cp in the film sticking-and-cutting device 1, the workpiece W is stopped and cooled. At the sticking position Pp in the film sticking-and-cutting device 1, the workpiece is cut by the cutters 13 while being stopped. In the vacuum laminator 4, the workpiece W is heated and pressed while being stopped. In the flat pressing device 5, the workpiece W is also heated and pressed while being stopped. In the downstream cooling device 6, the workpiece W is cooled while being stopped.

Each of the upstream cooling unit 2S and the downstream cooling device 6 controls the supply rate of the air, in synch with the acceleration/deceleration command signal S1 and the stop command signal S2. Specifically, as shown by the arrow T1, each of the upstream cooling unit 2S and the downstream cooling device 6 converts an acceleration command signal for the workpiece W to a decrease command signal for the supply rate of the air. As shown by the arrow T2, each of the upstream cooling unit 2S and the downstream cooling device 6 converts a signal for maintaining the workpiece W at a constant speed to a signal for maintaining the supply rate of the air at a constant value. As shown by the arrow T3, each of the upstream cooling unit 2S and the downstream cooling device 6 converts a deceleration command signal for the workpiece W to an increase command signal for the supply rate of the air. As shown by the arrow T4, each of the upstream cooling unit 2S and the downstream cooling device 6 converts a stop signal for the workpiece W to a signal for maintaining the supply rate of the air at a constant value.

The signal for maintaining the supply rate of the air at a constant value, which corresponds to the signal for maintaining the workpiece W at a constant speed, is lower than the signal for maintaining the supply rate of the air at a constant value, which corresponds to the stop signal for the workpiece W. Namely, the supply rate of the air, which corresponds to the former, is smaller than the supply rate of the air which corresponds to the latter.

Due to the aforementioned signal conversion, each of the upstream cooling unit 2S and the downstream cooling device 6 gradually increases the supply rate of the air to the workpiece W, from when the workpiece W enters from the entrance 2A, 6A until when the workpiece W stops therein. Then, each of the upstream cooling unit 2S and the downstream cooling device 6 maintains constant the supply rate of the air to the workpiece W stopped therein. Then, each of the upstream cooling unit 2S and the downstream cooling device 6 gradually decreases the supply rate of the air to the workpiece W which is accelerated from the stopped state so as to be delivered from the exit 2B, 6B.

In this embodiment, each of the upstream cooling unit 2S and the downstream cooling device 6 controls the supply rate of the air using the acceleration/deceleration command signal S1 and the stop command signal S2 for the conveyor C, the conveyance-sheet feeding device 3, and the conveyance-sheet winding device 7. In this case, the conveyor C, the conveyance-sheet feeding device 3, and the conveyance-sheet winding device 7 may be connected in series by a field network, and the upstream cooling unit 2S and the downstream cooling device 6 may also be connected in series to the same field network. In this case, it is recommendable to send and receive signals using or based on a communication method like Ether-Cat. This can simplify a wiring configuration and speed up a control operation.

Next, an operation and an effect of this embodiment are described.

First, a workpiece W is received, from outside, in the conveyance path 1R of the film sticking-and-cutting device 1, and is cooled by the upstream cooling unit 2S of the film sticking-and-cutting device 1 (first cooling step). Thereafter, the workpiece W is delivered from the upstream cooling unit 2S to the sticking members 12, films F are stuck by the sticking members 12, and the films F are cut by the cutters 13 (film sticking-and-cutting step).

Thereafter, the workpiece W with the films F is conveyed to the vacuum laminator 4, and the films F being heated are pressed onto the workpiece W to be joined thereto in a vacuum state (vacuum laminating step). Then, the workpiece W with the films F is conveyed to the flat pressing device 5, and is heated and pressed while being sandwiched between the first press plate 51 and the second press plate 52.

Thereafter, the workpiece W with films F is cooled by the downstream cooling device 6 (second cooling step). Thereafter, the workpiece W with the films F is conveyed to the conveyance-sheet winding device 7, and the support layers F1 are peeled from the films F on the workpiece W (film peeling step). Thereafter, the workpiece W laminated only with the insulating layer F2 is taken outside from the conveyance-sheet winding device 7.

In such a laminating process according to this embodiment, the upstream cooling unit 2S cools the workpiece W before the workpiece reaches the sticking position Pp at which the films F are stuck by the sticking members 12. Thus, the films F, which are to be stuck to the workpiece W subsequently, are cooled, and parts of the films F to be cut by the cutters 13 are cooled before the films F are cut. This avoids a situation where, before the film F is cut, the film F is partially melted or softened because of a temperature environment or the like, which makes it difficult to cut the film F. Thus, the film F can be properly cut. In addition, since it is not difficult to cut the film F, a situation in which a cut surface of the film F is roughened and/or the film F is wrinkled or stretched can be suppressed.

In addition, the workpiece W with the films F, which has been heated and pressed by the vacuum laminator 5 and the flat pressing device 5, is cooled by the downstream cooling device 6, and then the support layers F1 are peeled by the conveyance-sheet winding device 7. Thus, during the peeling of the support layer F1, a situation in which a part of the insulating layer F2 adheres to the support layer F1 because of a high temperature and is peeled together with the support layer F1 can be suppressed. This can suppress roughening of a surface of the insulting layer F2.

The downstream cooling device 6 in this embodiment gradually increases the supply rate of the air to the workpiece W from when the workpiece W enters from the entrance 6A until when the workpiece W stops therein. Thereafter, the downstream cooling device 6 maintains constant the supply rate of the air to the workpiece W stopped therein. Thus, since the films F on the workpiece W is gently cooled, thereby, warpage of the workpiece W with the films F, which may occur due to rapid temperature change of the workpiece, can be suppressed. Particularly in this embodiment, the films F on both sides of the workpiece W are gently cooled at the same supply rate of the air, so that a shrinkage speed difference between the films F is suppressed. Thus, occurrence of warpage can be effectively suppressed. In addition, since the supply rate of the air is temporarily reduced, energy consumption can be saved.

Thus, this embodiment can manufacture a workpiece W free of warpage, with an insulting layer F2 which is neither wrinkled nor stretched, and a smooth surface, and the workpiece W can be manufactured with a high throughput. Therefore, a non-defective product rate of workpieces W as laminated products, each of which is laminated with an insulting layer F2, can be improved.

In addition, in this embodiment, a workpiece is conveyed by the conveyance mechanism to which an acceleration/deceleration command signal and a stop command signal are inputted in a cyclic manner. Each of he upstream cooling unit 2S and the downstream cooling device 6 controls a supply rate of the air by converting an acceleration/deceleration command signal and a stop command signal to an increase/decrease command signal for the supply rate of the air and a maintenance command signal for the supply rate of the air, in synch with the acceleration/deceleration command signal and the stop command signal. Thus, it is possible to promote a simplifying a control process and speeding up control operations.

In this embodiment, the film sticking-and-cutting device 1 comprises the upstream cooling unit 2S. However, the upstream cooling unit 2S may be formed as an independent cooling device separated from the film sticking-and-cutting device 1.

### Second Embodiment

Next, a board laminating system S2 according to a second embodiment is described. The same reference numerals are given to the same components in this embodiment as those in the first embodiment, and redundant description is omitted.

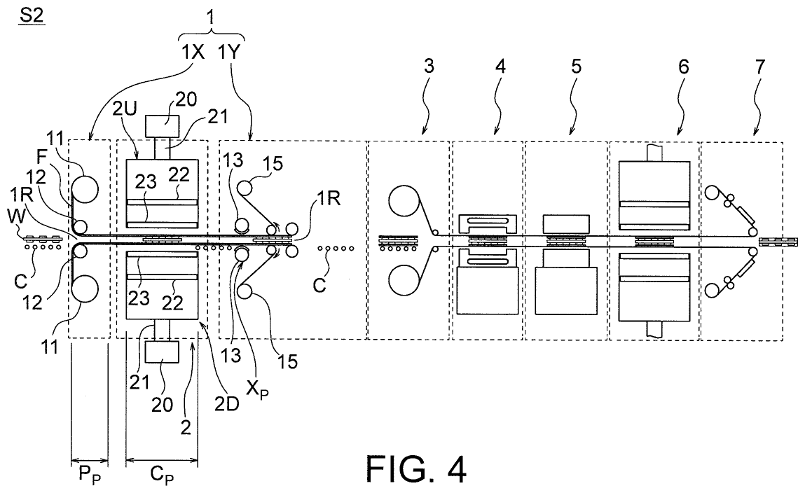

FIG. 4 schematically shows a board laminating system S2 according to a second embodiment. This embodiment differs from the first embodiment in the structure of a film sticking-and-cutting device 1. The film sticking-and-cutting device 1 includes a first portion 1X located on the upstream side in the conveyance direction of a workpiece W, and a second portion 1Y located on the downstream side away from the first portion 1X.

The first portion 1X is provided with a pair of film supply rolls 11 and a pair of sticking members 12. The second portion 1Y is provided with a pair of cutters 13. The second portion 1Y is further provided with a pair of film winding rolls 15. A distal end of a film F fed out from each film supply roll 11 is connected to the corresponding film winding roll 15.

In this embodiment, conveyors C are located on the upstream side and the downstream side of the film sticking-and-cutting device 1 in the conveyance direction of the workpiece W, but no conveyor C is located inside the film sticking-and-cutting device 1. Meanwhile, a conveyance path 1R of the film sticking-and-cutting device 1 is formed to be linearly aligned to the upstream conveyor C and the downstream conveyor C. The pair of film supply rolls 11, the pair of sticking members 12, and the pair of cutters 13, and the pair of film winding rolls 15 are respectively disposed on one side (upper side in FIG. 1) and the other side (lower side in FIG. 1) with respect to the conveyance path 1R.

In this embodiment, a film F extends between the film supply roll 11 and the film winding roll 15 in such a manner that the film F extends from the film supply roll 11 to the sticking member 12, and changes its direction by contacting the sticking member 12 to extend linearly up to the film winding roll 15. A part of the film F, which linearly extends from the sticking member 12 to the film winding roll 15, extends along the conveyance path 1R. The cutter 13 is located at a position in front of the film winding roll 15 such that it can move close to or away from the part of the film F, which linearly extends from the sticking member 12 to the film winding roll 15.

The reference numeral Xp in FIG. 4 shows a cutting position of the film F by the cutter 13. In the film sticking-and-cutting device 1 in this embodiment, when the film winding rolls 15 wind the films F, the workpiece W on the upstream conveyor C is drawn into a space between the pair of sticking member 12 to be conveyed to a sticking position Pp. Then, in the sticking position Pp, the films F are stuck by the sticking members 12 to the upper surface and the lower surface of the workpiece W, along with the movement of the the workpiece W. Then, the film winding rolls 15 further wind the films F so that the workpiece W reaches the cutting position Xp. At this time, the workpiece W is moved while being sandwiched between the films F. At the cutting position Xp, the film F is cut at a position where the film F is not overlapped with the workpiece W. Thus, the film F stuck to the workpiece W is separated from the film F extending between the film supply roll 11 and the film winding roll 15. The cutter 13 may be freely movable in a two-dimensional plane.

In this embodiment, an upstream cooling device 2 is located between the sticking position Pp for the film F and the cutting position Xp for the film F. At a cooling position Cp between the sticking position Pp and the cutting position Xp, the upstream cooling device 2 cools the film F on the workpiece W by supplying air to the film F.

The upstream cooling device 2 differs from the upstream cooling unit 2S in the first embodiment in that it is separated from the film sticking-and-cutting device 1. In addition, the installation position of the upstream cooling device 2 differs from that of the upstream cooling unit 2S in the first embodiment. Moreover, the upstream cooling device 2 differs from the upstream cooling unit 2S in that it directly cools the film F. However, other structure of the upstream cooling device 2 is the same as that of the upstream cooling unit 2S in the first embodiment. The upstream cooling device 2 performs control of the supply rate of the air in the same manner as that of the first embodiment. In this embodiment, the upstream cooling device 2 is separated from the film sticking-and-cutting device 1, but it may be incorporated in the film sticking-and-cutting device 1 as a component thereof. A conveyance-sheet feeding device 3, a vacuum laminator 4, a flat pressing device 5, a downstream cooling device 6, and a conveyance-sheet winding device 7 have the same structures as those of the first embodiment.

Also in this embodiment, a part of the film F to be cut by the cutter 13 is cooled by the upstream cooling device 2 before the film F is cut. This avoids a situation where, before the film F is cut, the film F is partially melted or softened because of a temperature environment or the like, which makes it difficult to cut the film F. Thus, the film F can be properly cut. In addition, since it is not difficult to cut the film F, a situation in which a cut surface of the film F is roughened and/or the film F is wrinkled or stretched can be suppressed. Therefore, a non-defective product rate of workpieces W as laminated products, each of which is laminated with an insulting layer F2, can be improved.

### Third Embodiment

Next, a board laminating system S3 according to a third embodiment is described. The same reference numerals are given to the same components in this embodiment as those in the first and second embodiments, and redundant description is omitted.

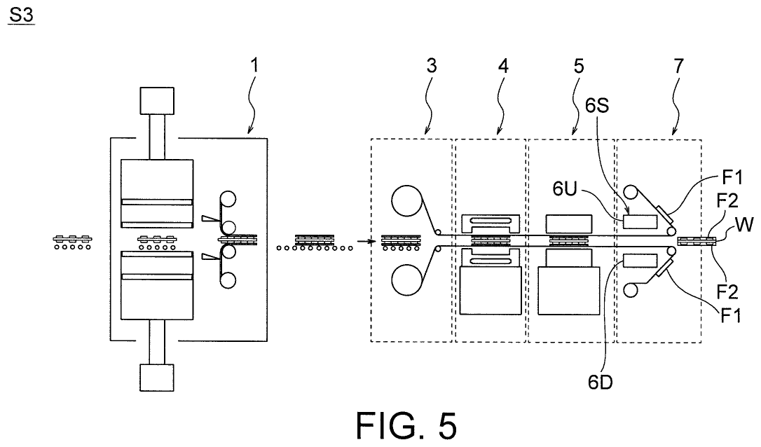

FIG. 5 schematically shows a board laminating system S3 according to a third embodiment. In this embodiment, a conveyance-sheet winding device 7 comprises a downstream cooling unit 6S. On the other hand, the downstream cooling device 6 described in the first and second embodiments is not provided.

The downstream cooling unit 6S cools films F on a upper surface and a lower surface of a workpiece W by respectively supplying air to the films, before support layers F1 of the films F on the upper surface and the lower surface of the workpiece W delivered from a vacuum laminator 4 are peeled.

The downstream cooling unit 6S includes a first downstream cooling unit 6U and a second downstream cooling unit 6D. As schematically shown in FIG. 5, the first downstream cooling unit 6U and the second downstream cooling unit 6D respectively have same structures as the first downstream cooling unit 6U and the second downstream cooling unit 6D described in the first embodiment. The downstream cooling unit 6S performs control of the supply rate of the air in the same manner as that of the first embodiment.

Also in this embodiment, a workpiece W with films F, which has been heated and pressed by the vacuum laminator 4 and the flat pressing device 5, is cooled by the downstream cooling unit 6S, and then the support layers F1 are peeled by the conveyance-sheet winding device 7. Thus, during the peeling of the support layer F1, a situation in which a part of the insulating layer F2 adheres to the support layer F1 because of a high temperature and is peeled together with the support layer F1 can be suppressed. This can suppress roughening of a surface of the insulting layer F2.

Also in this embodiment, the downstream cooling unit 6S gradually increases the supply rate of the air to the workpiece W until when the workpiece W stops therein. Thereafter, the downstream cooling unit 6S maintains constant the supply rate of the air to the workpiece W stopped therein. Thus, since the films F on the workpiece W is gently cooled, warpage of the workpiece W with the films F, which may occur due to rapid temperature change of the workpiece, can be suppressed. Particularly in this embodiment, the films F on both sides of the workpiece W are gently cooled at the same supply rate of the air, so that a shrinkage speed difference between the films F is suppressed. Thus, occurrence of warpage can be effectively suppressed.

Therefore, a non-defective product rate of workpieces W as laminated products, each of which is laminated with an insulting layer F2, can be improved.

### Fourth Embodiment

Next, a board laminating system S4 according to a fourth embodiment is described. The same reference numerals are given to the same components in this embodiment as those in the first to third embodiments, and redundant description is omitted.

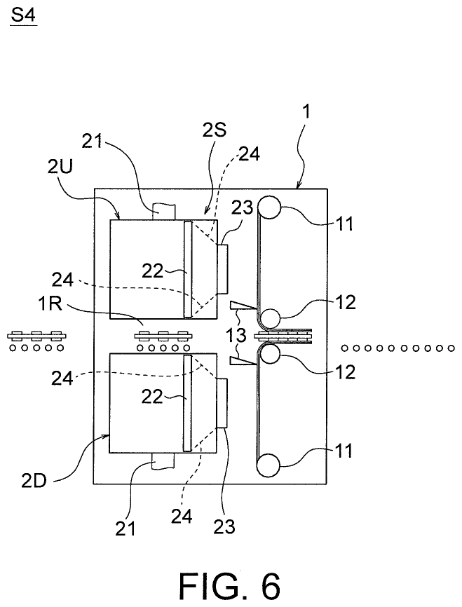

FIG. 6 schematically shows a board laminating system S4 according to a fourth embodiment. In more detail, FIG. 6 shows a film sticking-and-cutting device 1 of the board laminating system S4.

The film sticking-and-cutting device 1 in this embodiment differs from that the first embodiment in how air is supplied from an upstream cooling unit 2S. Namely, the upstream cooling unit 2S cools a film F before it is cut, by supplying air to the film F before it is stuck to the workpiece W.

In more detail, a sticking member 12 on one side is located close to a conveyance path 1R, and a film supply roll 11 on one side is located at a position farther away from the conveyance path 1R than the sticking member 12. A cutter 13 on one side is located such that it can move close to or away from a part of a film F, which extends between the film supply roll 11 on one side and the sticking member 12 on one side. Similarly, the sticking member 12 on the other side is located close to the conveyance path 1R, and the film supply roll 11 on the other side is located at a position farther away from the conveyance path 1R than the sticking member 12. The cutter 13 on the other side is located such that it can move close to or away from a part of a film F, which extends between the film supply roll 11 on the other side and the sticking member 12 on the other side.

A first cooling unit 2U in the upstream cooling unit 2S supplies air to the part of the film F, which extends between the film supply roll 11 on one side and the sticking member 12 on one side, at a position closer to the film supply roll 11 on one side than the cutter 13 on one side. A second cooling unit 2D in the upstream cooling unit 2S supplies air to the part of the film F, which extends between the film supply roll 11 on the other side and the sticking member 12 on the other side, at a position closer to the film supply roll 11 on the other side than the cutter 13 on the other side.

Each structure of the first cooling unit 2U and the second cooling unit 2D in the upstream cooling unit 2S is basically the same as that of the first embodiment. However, it differs from the first embodiment in that an air route from a fan filter unit 22 to an air supplying part 23 is formed such that a sectional area thereof gradually decreases toward the air supplying part 23 by means of airflow guide plates 24. On the other hand, control of the supply rate of the air by the upstream cooling unit 2S may be the same as or different from that of the first embodiment.

Also in this embodiment, a part of the film F to be cut by the cutter 13 is cooled by the upstream cooling unit 2S before the film F is cut. This avoids a situation where, before the film F is cut, the film F is partially melted or softened because of a temperature environment or the like, which makes it difficult to cut the film F. Thus, the film F can be properly cut. In addition, since it is not difficult to cut the film F, a situation in which a cut surface of the film F is roughened and/or the film F is wrinkled or stretched can be suppressed. Therefore, a non-defective product rate of workpieces W as laminated products, each of which is laminated with an insulting layer F2, can be improved.

### Fifth Embodiment

Next, a board laminating system S5 according to a fifth embodiment is described. The same reference numerals are given to the same components in this embodiment as those in the first to fourth embodiments, and redundant description is omitted.

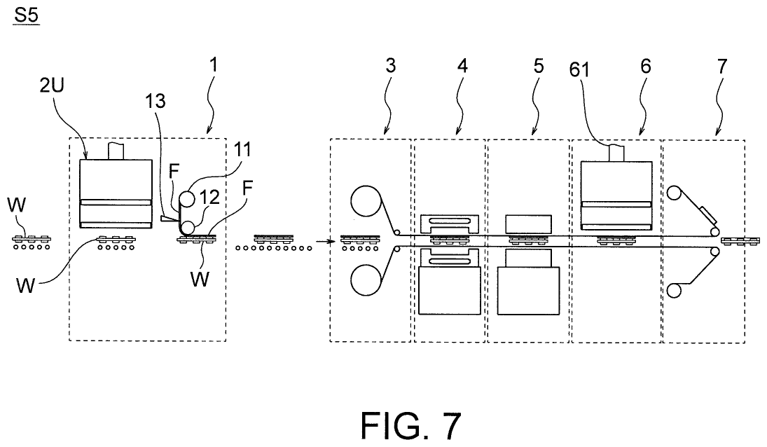

FIG. 7 schematically shows a board laminating system S5 according to a fifth embodiment. The board laminating system S5 laminates a film F only on one side of a workpiece W. Thus, the second cooling unit 2D in the upstream cooling unit 2S of the film sticking-and-cutting device 1 described in the first embodiment is not provided. On the lower side in FIG. 7, the film supply roll 11, the sticking member 12, and the cutter 13 are not provided. In addition, the downstream cooling device 6 does not have the second downstream cooling unit 6D. Other structures are the same as those of the first embodiment.

When the film F is laminated only on one side of the workpiece W in the second to fourth embodiment, the same members and devices can be deleted similarly to the fifth embodiment.

### Sixth Embodiment

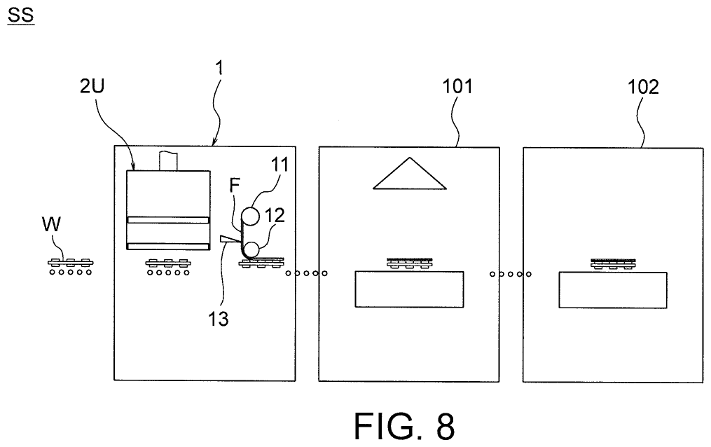

Next, a board laminating system S6 according to a sixth embodiment is described. The same reference numerals are given to the same components in this embodiment as those in the first to fifth embodiments, and redundant description is omitted. FIG. 8 is a view schematically showing a semiconductor manufacturing system SS comprising a film sticking-and-cutting device 1 according to the sixth embodiment.

The semiconductor manufacturing system SS comprises the film sticking-and-cutting device 1 described in the fifth embodiment, an exposure device 101, and a developing device 102.

The film sticking-and-cutting device 1 sticks a dry resist film as a film F to a workpiece W as a semiconductor wafer. The exposure device 10 exposes the film F, and cures a part of the film in a predetermined pattern. The developing device 102 removes an unnecessary portion of the film F. The developing device 102 may be of a spin rotation type or a dipping type. A laminator for pressing the film F onto the workpiece W may be provided between the exposure device 101 and the film sticking-and-cutting device 1.

The respective embodiments of the present invention have been described as above, but the present invention is not limited to the aforementioned embodiments.

1. A laminating system comprising:
a film sticking-and-cutting device that sticks a film fed from a roll to a workpiece, and cuts the film at a position where the film is not overlapped with the workpiece; and
a laminator that receives the workpiece delivered from the film sticking-and-cutting device, and presses the film stuck to the workpiece to the workpiece to join the film to the workpiece;
wherein the laminating system comprises a cooling device that cools the workpiece or the film by air, before the film is cut by the film sticking-and-cutting device.

2. The laminating system according to claim 1, wherein
the cooling device cools the workpiece by supplying air to the workpiece before the workpiece reaches a sticking position of the film in the film sticking-and-cutting device, or cools the film by supplying air to the film before the film is stuck to the workpiece, or cools the film by supplying air to the film on the workpiece between the sticking position of the film in the film sticking-and-cutting device and a cutting position of the film therein.

3. The laminating system according to claim 1, wherein
the cooling device includes an entrance for the workpiece and an exit for the workpiece, and
the cooling device gradually increases the supply rate of the air while the workpiece is moving from the entrance toward an intermediate position between the entrance and the exit, thereafter maintains constant the supply rate of the air, and thereafter gradually decreases the supply rate of the air.

4. The laminating system according to claim 3, wherein
the workpiece is conveyed in such a manner that the workpiece is repeatedly stopped and moved in a cyclic manner, and
the cooling device maintains constant the supply rate of the air while the workpiece is stopped therein.

5. The laminating system according to claim 4, wherein
the workpiece is conveyed by a conveyance mechanism to which an acceleration/deceleration command signal and a stop command signal are inputted in a cyclic manner, and
the cooling device controls the supply rate of the air by converting the acceleration/deceleration command signal and the stop command signal to an increase/decrease command signal for the supply rate of the air and a maintenance command signal for the supply rate of the air, in synch with the acceleration/deceleration command signal and the stop command signal.

6. The laminating system according to claim 3, wherein
the cooling device supplies the air at a constant supply rate until the workpiece reaches a predetermined temperature or lower.

7. A laminating system comprising:
a vacuum laminator that receives, in a vacuum chamber, a workpiece to which a film including a support layer and a joint layer is stuck, with the joint layer being in direct contact with the workpiece, creates a vacuum state in the vacuum chamber, and presses the film to the workpiece to join the film to the workpiece, while heating the film;
a cooling device that cools the film on the workpiece delivered from the vacuum laminator, by supplying air to the film; and
a film peeling device that peels the support layer from the film on the workpiece delivered from the cooling device;
wherein the cooling device varies the supply rate of the air in accordance with a conveyance pattern of the workpiece and/or a condition of the film on the workpiece.

8. The laminating system according to claim 7, wherein
the cooling device includes an entrance for the workpiece and an exit for the workpiece, and
the cooling device gradually increases the supply rate of the air while the workpiece is moving from the entrance toward an intermediate position between the entrance and the exit, thereafter maintains constant the supply rate of the air, and thereafter gradually decreases the supply rate of the air.

9. The laminating system according to claim 8, wherein
the workpiece is conveyed in such a manner that it is repeatedly stopped and moved in a cyclic manner, and
the cooling device maintains constant the supply rate of the air while the workpiece is stopped therein.

10. The laminating system according to claim 9, wherein
the workpiece is conveyed by a conveyance mechanism to which an acceleration/deceleration command signal and a stop command signal are inputted in a cyclic manner, and
the cooling device controls the supply rate of the air by converting the acceleration/deceleration command signal and the stop command signal to an increase/decrease command signal for the supply rate of the air and a maintenance command signal for the supply rate of the air, in synch with the acceleration/deceleration command signal and the stop command signal.

11. The laminating system according to claim 8, wherein
the cooling device supplies the air at a constant supply rate until the workpiece reaches a predetermined temperature or lower.

12. A cooling device for laminating system, comprising:
an entrance for a workpiece on which a film is not yet stacked or a workpiece on which a film has been already stacked, and an exit for the workpiece;
wherein
the cooling device for laminating system cools, between the entrance and the exit, the workpiece on which the film is not yet stacked by supplying air to the workpiece, or the film on the workpiece on which the film has been already stacked by supplying air to the film, and
the cooling device for laminating system varies the supply rate of the air in accordance with at least any of a conveyance pattern of the workpiece, a condition of the workpiece, and a condition of the film on the workpiece.

13. The cooling device for laminating system according to claim 12, wherein
the cooling device for laminating system gradually increases the supply rate of the air while the workpiece is moving from the entrance toward an intermediate position between the entrance and the exit, thereafter maintains constant the supply rate of the air, and thereafter gradually decreases the supply rate of the air.

14. The cooling device for laminating system according to claim 13, wherein
the workpiece is conveyed in such a manner that it is repeatedly stopped and moved in a cyclic manner, and
the cooling device for laminating system maintains constant the supply rate of the air while the workpiece is stopped therein.

15. The cooling device for laminating system according to claim 13, wherein
the cooling device for laminating system supplies the air at a constant supply rate until a temperature of the workpiece on which the film is not yet stacked, or a temperature of the workpiece on which the film has been already stacked, reaches a predetermined temperature or lower.

16. A film sticking-and-cutting device that sticks a film fed from a roll to a workpiece, and cuts the film at a position where the film is not overlapped with the workpiece,
wherein the film sticking-and-cutting device includes a cooling unit that cools the workpiece or the film by air, before the film is cut.

17. The film condign and cutting device according to claim 16, wherein
the cooling unit cools the workpiece by supplying air to the workpiece before the workpiece reaches a sticking position of the film, or cools the film before the film is stuck to the workpiece by supplying air to the film, or cools the film on the workpiece between the sticking position of the film and a cutting position of the film by supplying air to the film.

18. A film peeling device that peels, from a film including a support layer and a joint layer, the support layer, with the joint layer being directly joined to a workpiece to which the film is joined,
wherein
the film peeling device comprises a cooling unit that cools the film by supplying air to the film on the workpiece, before the support layer is peeled, and
the cooling unit varies the supply rate of the air in accordance with a conveyance pattern of the workpiece and/or a condition of the film on the workpiece.

19. A laminating method comprising:
a film sticking-and-cutting step that sticks a film fed from a roll to a workpiece, and cuts the film at a position where the film is not overlapped with the workpiece; and
a laminating step that receives the workpiece delivered after the film sticking-and-cutting step, and presses the film stuck to the workpiece to the workpiece to join the film to the workpiece;
wherein the laminating method comprises a cooling step that cools the workpiece or the film by air, before the film is cut in the film sticking-and-cutting step.

20-23. (canceled)
